(19) United States
(12) Patent Application Publication
(10) Pub. No.: US 2014/0267727 A1
(43) Pub. Date: Sep. 18, 2014

(54) SYSTEMS AND METHODS FOR DETERMINING THE FIELD OF VIEW OF A PROCESSED IMAGE BASED ON VEHICLE INFORMATION

(71) Applicant: HONDA MOTOR CO., LTD., Tokyo (JP)

(72) Inventor: Arthur Alaniz, Cupertino, CA (US)

(73) Assignee: HONDA MOTOR CO., LTD., Tokyo (JP)

(21) Appl. No.: 13/827,517

(22) Filed: Mar. 14, 2013

(51) Int. Cl. H04N 7/18

(52) U.S. Cl. CPC H04N 7/183
USPC 348/148

(57) ABSTRACT

Systems and methods for determining a field of view, based on vehicle data, for displaying an image captured by a vehicle mounted camera. A system for determining a field of view includes a receiver configured to receive an image having a first field of view from an image capturing device, a processor configured to process the image based on vehicle data and output a processed image that has a second field of view that is narrower than the first field of view, and a transmitter configured to transmit the processed image to a display for presentation to an occupant of the vehicle. Computer-implemented methods are also described herein.

### TECHNICAL FIELD

The systems and methods described herein relate generally to determining the field of view of an image based on vehicle information, and, more specifically, the systems and methods described herein relate to changing the field of view of an image that is displayed in a vehicle, where the image is captured by an vehicle based image capturing device, and the field of view is determined by a vehicle computing device based on the velocity of the vehicle.

### BRIEF DESCRIPTION OF THE DRAWINGS

FIG. 1 depicts a vehicle that includes a display in communication with a vehicle computing device.

FIG. 2 depicts example displays in a vehicle.

FIGS. 3A-3C depict example fields of view and corresponding displays for a vehicle computing device that selects the field of view based on vehicle information.

FIG. 4 depicts example selected fields of view based on vehicle information.

FIG. 5 depicts an exemplary hardware platform.

FIG. 6 is a flowchart of an exemplary process for selectively changing the field of view of a display based on vehicle information.

### SUMMARY

The systems and methods described herein can be used to determine a field of view for displaying an image captured from a vehicle mounted camera based on vehicle data.

In accordance with one embodiment, a system includes a receiver that is configured to receive an image having a first field of view and a processor that is communication with the receiver and configured to determine a second field of view based on vehicle data. The second filed of view is narrower than the first field of view. The processor is also configured to process the image to generate a processed image having the second field of view and output the processed image. The system also includes a transmitter that is in communication with the processor and configured to transmit the processed image.

In accordance with another embodiment, a method includes receiving by a processor vehicle data that is associated with a vehicle. The method also includes processing an image having a first field of view by the processor based at least in part on the vehicle data to generate a processed image having a second field of view narrower than the first field of view and outputting the processed image.

In accordance with another embodiment, a vehicle information system includes a means for capturing a forward-facing image from the vehicle, where the image has a first field of view, a means for processing the image to generate a processed image having a second field of view, the second field of view based at least in part on velocity data associated with the vehicle, and a means for displaying, in the vehicle, the processed image.

### DETAILED DESCRIPTION

The systems, apparatuses, devices, and methods disclosed herein are described in detail by way of examples and with reference to the figures. It will be appreciated that modifications to disclosed and described examples, arrangements, configurations, components, elements, apparatuses, devices, systems, methods, etc. can be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The systems, apparatuses, devices, and methods disclosed herein describe systems, apparatuses, devices, and methods for selectively changing the field of view of a display based on vehicle information, with selected examples disclosed and described in detail with reference made to FIGS. 1-6. In one example, the field of view can be based at least in part on the velocity of the vehicle. Although the systems, apparatuses, devices, and methods disclosed and described herein can be used to selectively change the field of view of a display, those of ordinary skill in the art will recognize that any other suitable means for selectively changing the field of view can be used, and the field of view can be based on data including, without limitation, data from a Global Positioning System (GPS) device, mobile devices such as smartphones, inertial devices, user input, image processing determinations, information from vehicle accessories, and data available on a vehicle controller area network (CAN). Similarly, terms such as “image,” “picture,” “video,” “streaming video,” “video stream,” and terms such as “position,” “speed,” “velocity,” and “acceleration” can similarly be used without the intent to limit the disclosure to a specific embodiment, unless specifically referred to as an embodiment. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

References to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, but also data structures, data stores and computing instructions in any electronic format, firmware, and embedded software. The terms “information” and “data” are used expansively and includes a wide variety of electronic information, including but not limited to machine-executable or machine-interpretable instructions; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack.

The examples discussed below are examples only and are provided to assist in the explanation of the systems, apparatuses, devices, and methods described herein. None of the features or components shown in the drawings or discussed below should be taken as mandatory for any specific implementation of any of these the systems, apparatuses, devices, or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Referring now to FIG. 1, example elements of a vehicle camera display system 100 are presented. The vehicle camera display system 100 can include a forward-facing vehicle-mounted camera 102 having wide angle-of-view 104, a vehicle computing device 106, and a vehicle display 112. The vehicle computing device 106 can include one or more display outputs 108 for outputting a signal for displaying an image on the display 112. The vehicle computing device 106 can include one or more camera inputs 110 for accepting images or video from one or more cameras 102 associated with a vehicle 120. The vehicle computing device 106 can be connected to the camera 102 and vehicle display 112 using suitable cables 114A, 114B for transmitting video signals. In other configurations, the video data can be packetized and transmitted using Ethernet or other suitable data cables, or can be transmitted wirelessly. In certain configurations, the vehicle computing device 106 can be an integrated system that includes the camera 102, vehicle computing device 106, and vehicle display 112. In various configurations, various components of the vehicle computing device 106 can be integrated, separate components, or integrated into existing vehicle components or the vehicle electronics 124.

The vehicle computing device 106 can include computer executable instructions capable of executing on a computing platform such as a desktop, laptop, tablet, mobile computing device, an embedded processor, or other suitable hardware. The computer executable instructions can include software modules, processes, application programming interfaces or APIs, drivers, helper applications such as plug-ins, databases such as search and query databases, and other types of software modules or computer programming as would be understood in the art.

The vehicle 120 can include a cabin area 122 for occupants. The vehicle camera display system 100 can extend into the cabin area 122, can be completely within the cabin area 122, or can be viewable from the cabin area 122. The vehicle can also include vehicle electronics 124, and a vehicle network 126. The vehicle electronics 124 can provide vehicle data, including but not limited to vehicle velocity, speed, direction, acceleration, position, blinker activation, driving conditions, and other information. The vehicle network 126 can be a vehicle controller area network (CAN). The vehicle camera display system 100 can receive vehicle data. For example, the vehicle computing device 106 can be in communication with, and receive vehicle data from, the vehicle network 126. The vehicle computing device 106 can be physically connected via a wired connection such as an Ethernet connection, or other suitable data connection, to the vehicle network 126. The vehicle computing device 106 can use one or more wireless technologies to communicate through the vehicle network 126 with the vehicle electronics 124, including but not limited to WiFi™, Bluetooth™, ZigBee™, one of the IEEE 802.11x family of network protocols, or another suitable wireless network protocol.

The vehicle display 112 can display an image captured by the forward-facing vehicle-mounted camera 102. Referring now to FIG. 2, example configurations and placements of the display 112 in the cabin 122 of the vehicle are presented. The vehicle display 112 can be associated with a vehicle structure. For example, the vehicle display 112B can be integrated into the dashboard. In another example, the vehicle display 112C can be integrated into an overhead console. The vehicle display 112D can be separate and mounted to or placed on the dashboard of the vehicle. The vehicle display 112A can use a heads up display technology. In certain configurations, the functionality of the vehicle computing device 106 and vehicle display 112 can be incorporated into existing equipment or other devices. For example, the functionality can be implemented into an application or app that executes on a mobile computing device or smart phone and uses the display 112E of the mobile computing device. In one configuration, the app can be an application executing on a mobile phone, for example an app available from the Apple™ iStore™, or other app store, for downloading onto and executing on an Apple™ iPhone™.

Referring to FIGS. 3A, 3B, and 3C, example implementations of wide, intermediate, and narrow fields of view 302 and corresponding example displayed images 304 are illustrated. An image capturing device (e.g., item 102 of FIG. 1) can capture a full field image 306, represented by the solid box, and transmits the image 306 to a vehicle computing device (e.g., item 106 of FIG. 1). The vehicle computing device performs an image transformation that transforms the full field image 306, for example through cropping and resizing the image, into the selected wide, intermediate, or narrow field of view 302, illustrated by the dashed boxes. The selected wide, intermediate, or narrow field of view 302 is then displayed as illustrated for each of the example displayed images 304.

Referring first to FIG. 3A, an example implementation of a wide field of view 302A is illustrated. An example of a corresponding example displayed image 304A for the wide field of view 302A is illustrated. The displayed image 304A for the wide field of view 302A is approximately the image that would be displayed if the vehicle camera (not shown) captured an image using a lens and imaging element having an angle-of-view of θ1. Referring next to FIG. 3B, an example implementation of an intermediate field of view 302B is illustrated. An example of a corresponding example displayed image 304B for the intermediate field of view 302B is illustrated. The displayed image 304B for the intermediate field of view 302B is approximately the image that would be displayed if the vehicle camera (not shown) captured an image using a lens and imaging element having an angle-of-view of θ2. Referring next to FIG. 3C, an example implementation of a narrow field of view 302C is illustrated. An example of a corresponding example displayed image 304C for the narrow field of view 302C is illustrated. The displayed image 304C for the narrow field of view 302C is approximately the image that would be displayed if the vehicle camera (not shown) captured an image using a lens and imaging element having an angle-of-view of θ3.

Referring now to FIG. 4, an example mapping 400 of vehicle data 402 to fields of view 302, and to the approximately equivalent angle-of-view θ1, θ2, and θ3, are illustrated. As is to be appreciated, while three angles of view, θ1, θ2, and θ3, are illustrated in FIG. 4, other embodiments can use θN angles of view, where N is any suitable positive integer. In an example configuration, at speeds below a bottom speed threshold the processor can create a processed image that has a wide angle view. In the illustrated embodiment, the bottom speed threshold is 20 miles per hour (MPH) in a forward direction. To achieve a wide angle view, the processor can use the full frame image data as the processed image, or a lesser amount of the full frame image data that can be resized, if necessary, to the area of the display. In various configurations, the processor can crop, resize, translate, or perform other suitable image transformations to present a suitable wide angle view. At speeds above a top speed threshold the processor can create a processed image from the image data that has a narrow angle view, and the processed image can be resized to fit the area of the display. In the illustrated embodiment, the top speed threshold is 50 MPH. At intermediate speeds between the bottom speed threshold and the top speed threshold, for example when the vehicle is travelling between 20 MPH and 50 MPH, the processor can create a processed image from the image data that is between the wide angle view and the narrow angle view, and the processed image can be resized to fit the area of the display.

The processor can use other suitable methods of determining a field of view for a processed image, including but not limited to using a lookup table to determine a field of view appropriate for the velocity of the vehicle, an algorithm for determining a field of view based on speeds or other vehicle data, a step algorithm, a curvilinear algorithm, a logarithmic algorithm, a proportional algorithm, or other suitable mapping or correlation of the field of view of the processed image to the vehicle data, such as speed, velocity or acceleration. The changes to the field of view, from a first processed image to subsequent processed images, can be smoothed, a hysteresis function can be applied, or other suitable methods of presenting changes to the field of view can be performed. As such, relatively rapid changes in field of view around speed thresholds can be prevented or reduced and sudden jump discontinuities in the field of view due to operational conditions can be mitigated.

A field of view of a processed image that is presented to an occupant of the vehicle can be configured to approximately correlate to the time of impact, based on vehicle velocity, with an object visualized in the field of view. By narrowing the field of view and resizing the image as speed increases, obstacles in the path of the vehicle can be made to appear larger in the displayed image, thereby bringing the obstacle to the driver's attention. For example, an animal, such as a deer, that is some distance away from the vehicle, may appear small, indistinct, or otherwise difficult to resolve either visually by the driver. Even if the vehicle is equipped with a forward-looking vehicle-mounted camera and associated display, if the image being displayed is an unmodified image, the animal may only occupy a relatively small portion of the display. At high speeds, a travelling vehicle may close the distance to the animal in a short time, providing only a limited amount of time for the driver to see the animal. By narrowing the field of view as the vehicle's speed increases, in accordance with the systems and methods described herein, the image presented to the driver can include an enlarged display of the animal, due to the resizing of the display caused by narrowing the field of view. As the vehicle approaches, the animal will continue to grow in size on the display, further alerting the driver or other occupants of the animal's presence in the roadway. This can provide a valuable, timely visual indicator to the driver that an animal, or any obstacle, is being approached. Similarly, by narrowing the field of view, the driver will be alerted to the presence of stalled or slower cars in the roadway ahead.

Referring now to FIG. 5, example elements of an exemplary computing device 500 are illustrated. A computing device 500 can be a vehicle computing device, vehicle electronics, a server, or mobile computing device. The computing device also can be any suitable computing device as would be understood in the art, including but not limited to an embedded processing device, a desktop, a laptop, a tablet computing device, and an e-ink reading device. The computing device 500 includes a processor 502 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 500 also includes one or more memories 506, for example read only memory (ROM), random access memory (RAM), cache memory associated with the processor 502, or other memories such as dynamic RAM (DRAM), static ram (SRAM), flash memory, a removable memory card or disk, a solid state drive, and so forth. The computing device 500 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor 502, or memories 506 are also contemplated as storage devices.

The network and communication interfaces 512 allow the computing device 500 to communicate with other devices across a network 514. The network and communication interfaces 512 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 512 can include wired data transmission links such as Ethernet and TCP/IP. The communication interfaces 512 can include wireless protocols for interfacing with private or public networks 514. For example, the network and communication interfaces 512 and protocols can include interfaces for communicating with private wireless networks such as a WiFi network, one of the IEEE 802.11x family of networks, or another suitable wireless network. The network and communication interfaces 512 can include interfaces and protocols for communicating with public wireless networks 512, using for example wireless protocols used by cellular network providers, including Code Division Multiple Access (CDMA) and Global System for Mobile Communications (GSM). A computing device 500 can use network and communication interfaces 512 to communicate with hardware modules such as a database or data store, or one or more servers or other networked computing resources. Data can be encrypted or protected from unauthorized access.

In various configurations, the computing device 500 can include a system bus 513 for interconnecting the various components of the computing device 500, or the computing device 500 can be integrated into one or more chips such as programmable logic device or application specific integrated circuit (ASIC). The system bus 513 can include a memory controller, a local bus, or a peripheral bus for supporting input and output devices 504, inertial devices 508, GPS and inertial devices 510, and communication interfaces 512. Example input and output devices 504 include keyboards, keypads, gesture or graphical input devices, motion input devices, touchscreen interfaces, one or more displays, audio units, voice recognition units, vibratory devices, computer mice, and any other suitable user interface. In a configuration, the input and output devices 504 can include one or more receivers 516 for receiving video signals from imaging devices, and one or more transmitters 518 for transmitting video signals to displays. The input and output devices 504 can also include video encoders and decoders, and other suitable devices for sampling or creating video signals and other associated circuitry. In a configuration, a transmitter includes the associated circuitry. In a configuration, a receiver includes the associated circuitry. For example, the receiver 516 can receive an NTSC video signal from a video camera, associated circuitry can capture the individual frames of video at a desired resolution to produce a full frame image, the processor 502 or another processing device can perform image processing on the full frame image to generate a processed image, associated circuitry can encode the processed image in a format suitable for display on a display, such as a video graphics array (VGA) or high definition media interface (HDMI) format, and the transmitter 518 can output a video signal in the appropriate format for display. An example GPS device 510 can include a GPS receiver and associated circuitry. Inertial devices 508 can include accelerometers and associated circuitry. The associated circuitry can include additional processors 502 and memories 506 as appropriate.

The processor 502 and memory 506 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

Referring now to FIG. 6, an exemplary flowchart of the operation of a process for selecting the field of view of an image to display, based at least in part on vehicle information, is presented. Operation starts with start block 600 labeled START, where a process for determining a field of view for a processed image begins executing. Processing continues to process block 602 where an image is captured by an image capture device (e.g., a camera) associated with a vehicle. For example, a vehicle mounted camera can capture an image, a series of images, or a video. A vehicle mounted camera can capture a forward looking view, for example facing forward from the vehicle in approximately the direction of travel. In certain configurations, a vehicle camera can capture a rearward looking view, for example facing rearward from the vehicle in approximately the direction of travel (e.g., vehicle travelling in reverse). The vehicle mounted camera can capture the image using a first field of view, for example using a wide angle field of view camera mounted on the vehicle bumper, from the inside of the cabin of the vehicle through the windshield, or from any other suitable part of the vehicle. Processing continues to process block 604.

In process block 604, vehicle data is received. Vehicle data can include vehicle velocity, speed, direction, acceleration, blinker activation, steering wheel movement, and other information. In certain configurations, the vehicle data can be received from a vehicle controller area network (CAN). The vehicle data can also be received from any suitable source, including but not limited to information received from a Global Positioning System (GPS) device, mobile devices such as smartphones, inertial devices, user input, image processing determinations, and information from vehicle accessories. The vehicle data received in process block 604 can be received before, after or concurrent with the image data captured in process block 602. Processing continues to process block 606.

In process block 606, a processor receives the image data from the image capturing device captured in process block 602. The vehicle data received in process block 604 can be correlated with the image data captured in process block 602. Processing continues to process block 608.

In process block 608, a processor determines the field of view to be used for the processed image. To achieve a desired field of view, the processor can crop, resize, or perform other suitable image transformations to present a suitable field of view, including using the full frame image data as the processed image. The processor can use suitable methods of changing the field of view, including but not limited to using a lookup table to determine a field of view that is appropriate for the velocity of the vehicle, an algorithm for determining a field of view based on speeds or other vehicle data, a step algorithm, a curvilinear algorithm, a logarithmic algorithm, a proportional algorithm, or other suitable mapping of the field of view of the processed image to the vehicle data such as speed or velocity. Processing continues to process block 610.

In process block 610, a processor performs image processing to the image data to create a processed image. The processor can crop, resize, translate, or perform other suitable image transformations to present a suitable angle field of view in the processed image. Optionally, the changes to the field of view, from a first processed image to subsequent processed images, can be smoothed, a hysteresis function can be applied, or other suitable methods of presenting changes to the field of view can be performed. Such image processing techniques may seek to avoid rapid changes in field of view around speed thresholds or to prevent sudden jump discontinuities in the field of view. Processing continues to process block 612.

In process block 612, the processed image having the field of view determined by process block 608 is transmitted to the display. Processing continues to process block 614.

In process block 614, the processed image is displayed on a display device associated with the vehicle. The display device can be a display integrated into the vehicle, for example a display physically integrated in the dashboard of a vehicle. The display device can be any suitable display configured to provide the processed image to a vehicle occupant, including but not limited to a display mounted on the dashboard or attached to a vehicle structure, a mobile device such as a smartphone, a projection such as a heads up display, a wearable device such as glasses configured to display an image, or any other suitable display device. Processing continues to decision block 616.

In decision block 616, if there are more images to be display, processing returns to process block 602 to capture an additional image. Because images can be captured rapidly, for example video can be captured at 30 frames, or images, per second or higher, the received vehicle data operations of process block 604 need not be performed for each iteration. For example, the vehicle data operations of process block can be performed once every second, or approximately one per thirty operations of capturing and displaying the process image. If there are no more images to be displayed, operation terminates at end block 618 labeled END.

The above descriptions of various components, devices, apparatuses, systems, modules, and methods are intended to illustrate specific examples and describe certain ways of making and using the components, devices, apparatuses, systems, and modules disclosed and described here. These descriptions are neither intended to be nor should be taken as an exhaustive list of the possible ways in which these components, devices, apparatuses, systems, and modules can be made and used. A number of modifications, including substitution between or among examples and variations among combinations can be made. Those modifications and variations should be apparent to those of ordinary skill in this area after having read this document.

What is claimed is:

1. A system, comprising:
a receiver configured to receive an image that has a first field of view;
a processor in communication with the receiver and configured to
determine, based on vehicle data, a second field of view that is narrower than the first field of view,
process the image to generate a processed image that has the second field of view, and
output the processed image; and
a transmitter in communication with the processor and configured to transmit the processed image.

2. The system of claim 1, further comprising:
a forward-facing vehicle-mounted image capturing device configured to capture the image and transmit the image to the receiver.

3. The system of claim 2, wherein the vehicle data is obtained from a vehicle controller area network (CAN).

4. The system of claim 1, further comprising:
a display in communication with the transmitter configured to display the processed image.

5. The system of claim 4, wherein the display is associated with a vehicle structure.

6. The system of claim 1, and wherein the processor is further configured to
generate the processed image using a wide angle view when the vehicle data indicates that a vehicle is travelling below a bottom speed threshold, and
generate the processed image using a narrow angle view when the vehicle data indicates that the vehicle is travelling above a top speed threshold.

7. The system of claim 6, wherein the processor is configured to generate the processed image using a second field of view that is between the wide angle view and the narrow angle view when the vehicle data indicates that the vehicle is travelling below the top speed threshold and above the bottom speed threshold.

8. The system of claim 1, wherein the second field of view is determined based on a velocity of a vehicle received in the vehicle data, and wherein an angle-of-view visualized by the processed image is inversely proportional to the velocity of the vehicle.

9. The system of claim 8, wherein the processor is further configured to generate the processed image, based on the velocity data, that correlates a visualization of an object in the second field of view with the time to impact the object visualized in the second field of view.

10. A method, comprising:
receiving, by a processor, vehicle data associated with a vehicle;
processing an image having a first field of view, by the processor, based at least in part on the vehicle data to generate a processed image having a second field of view narrower than the first field of view; and
outputting the processed image.

11. The method of claim 10, further comprising:
capturing, by a forward-facing vehicle-mounted image capturing device, an image; and
transmitting the image to the processor.

12. The method of claim 10, wherein outputting the processed image further includes displaying the processed image using a display associated with the vehicle.

13. The method of claim 10, wherein processing comprises:
generating the processed image using a wide angle view when the vehicle data indicates that the vehicle is travelling below a bottom speed threshold, and
generating the processed image using a narrow angle view when the vehicle data indicates that the vehicle is travelling above a top speed threshold.

14. The method of claim 13, wherein processing further comprises:
generating the processed image using a second field of view that is between the wide angle view and the narrow angle view when the vehicle data indicates that the vehicle is travelling below the top speed threshold and above the bottom speed threshold.

15. The method of claim 10, wherein the second field of view is determined based on a velocity of the vehicle received in the vehicle data, and wherein an angle-of-view visualized by the processed image is inversely proportional to the velocity of the vehicle.

16. The method of claim 15, wherein based on the velocity, the processor generates the processed image that correlates a visualization of an object in the second field of view with the time to impact the object visualized in the second field of view.

17. A vehicle information system, comprising:
a means for capturing a forward-facing image from a vehicle, the image having a first field of view;
a means for processing the image to generate a processed image having a second field of view, the second field of view based at least in part on velocity data associated with the vehicle; and
a means for displaying, in the vehicle, the processed image.

18. The vehicle information system of claim 17, wherein the second field of view is based on the velocity data, and wherein an angle-of-view visualized by the processed image is inversely proportional to the velocity of the vehicle represented in the velocity data.

19. The vehicle information system of claim 17, wherein the second field of view is a wide angle view when the vehicle data indicates that the vehicle is travelling below a bottom speed threshold, and wherein the second field of view is a narrow angle view when the vehicle data indicates that the vehicle is travelling above a top speed threshold.

20. The vehicle information system of claim 19, wherein the processed image is configured to correlate a visualization of an object in the second field of view with the time to impact the object visualized in the second field of view.
